(19) United States
(12) Patent Application Publication
(10) Pub. No.: US 2019/0289154 A1
(43) Pub. Date: Sep. 19, 2019

(54) INFORMATION PROCESSING APPARATUS AND INFORMATION PROCESSING METHOD

(71) Applicant: CANON KABUSHIKI KAISHA, Tokyo (JP)

(72) Inventor: Yuichi Konosu, Saitama-shi (JP)

(21) Appl. No.: 16/298,965

(22) Filed: Mar. 11, 2019

(30) Foreign Application Priority Data
Mar. 14, 2018 (JP) 2018-046573

(51) Int. Cl. H04N 1/00

(52) U.S. Cl. CPC H04N 1/00896; H04N 2201/0094; H04N 1/0088

(57) ABSTRACT

An information processing apparatus configured to operate in a first power state and to operate in a second power state that saves more power than in the first power state, the information processing apparatus includes a first processor configured to execute a first program to control the information processing apparatus operating in the first power state; and a second processor configured to execute a second program to receive and process an instruction for shifting the information processing apparatus from the second power state to the first power state when the information processing apparatus operates in the second power state, wherein the information processing apparatus verifies the first program to be executed by the first processor, and the second program to be executed by the second processor.

### BACKGROUND OF THE INVENTION

### Field of the Invention

The present invention relates to an information processing apparatus and an information processing method.

### Description of the Related Art

Schemes for attacking computers and multi-function peripherals by tampering programs have become an issue.

Japanese Patent Application Laid-Open No. 2005-148934 discusses a technique for determining the validity of a program.

There is a system in which different programs are used in different power states. In such a system, if a program that operates in a second power state is tampered, for example, processing based on the tampered program is executed in the second power state.

### SUMMARY OF THE INVENTION

According to an aspect of the present invention, An information processing apparatus configured to operate in a first power state and to operate in a second power state that saves more power than in the first power state, the information processing apparatus includes a first processor configured to execute a first program to control the information processing apparatus operating in the first power state; and a second processor configured to execute a second program to receive and process an instruction for shifting the information processing apparatus from the second power state to the first power state when the information processing apparatus operates in the second power state, wherein the information processing apparatus verifies the first program to be executed by the first processor, and the second program to be executed by the second processor.

Further features of the present invention will become apparent from the following description of embodiments with reference to the attached drawings.

### BRIEF DESCRIPTION OF THE DRAWINGS

FIG. 1 is a block diagram illustrating an example of a hardware configuration of an image forming apparatus.

FIG. 2 is a block diagram illustrating an example of a functional configuration of the image forming apparatus.

FIGS. 3A and 3B are blocks diagrams schematically illustrating a start-up sequence.

FIG. 4 is a flowchart executed when a tampering detection is performed at a start-up time of the image forming apparatus.

FIG. 5 is a flowchart executed in a case where a tampering detection is performed at a time of sleep mode transition.

FIGS. 6A and 6B are block diagrams each illustrating an example of a power state.

### DESCRIPTION OF THE EMBODIMENTS

An embodiment of the present invention will be described below with reference to the drawings.

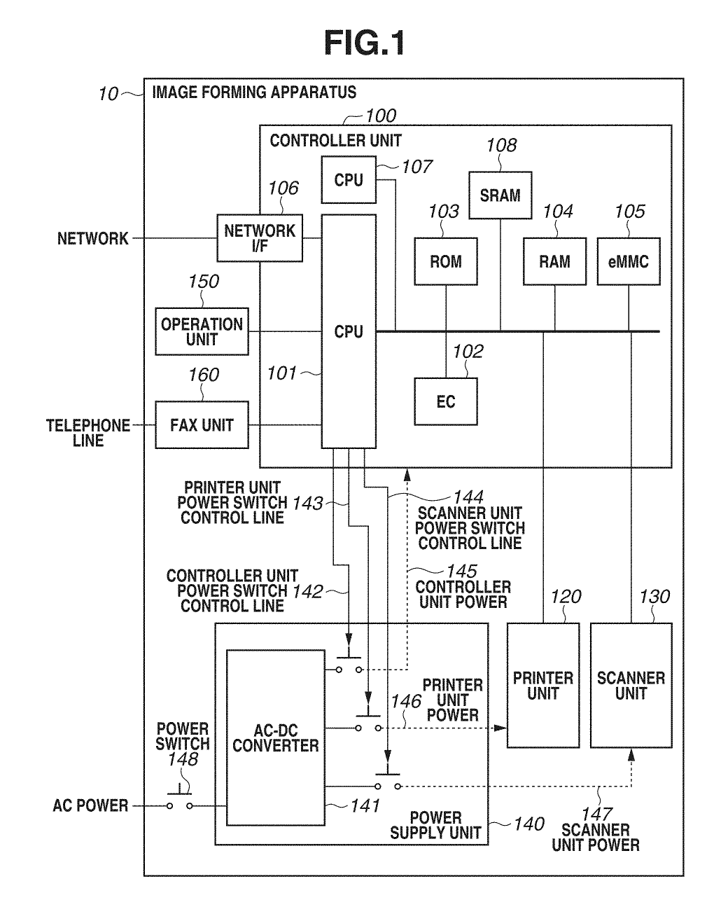

FIG. 1 is a block diagram illustrating an example of a hardware configuration of an image forming apparatus 10. The image forming apparatus 10 is an example of an information processing apparatus.

An operation unit 150 includes a numeric keypad for operating the image forming apparatus 10, a liquid crystal panel for display, and a light emitting diode (LED) for notifying a status of the image forming apparatus 10 by lighting/blinking.

A scanner unit 130 optically reads an image from a document and converts the read image into a digital image.

A printer unit 120 is an engine that outputs the digital image onto a paper medium.

A controller unit 100 controls each device and each unit. The controller unit 100 is a general-purpose central processing unit (CPU) system.

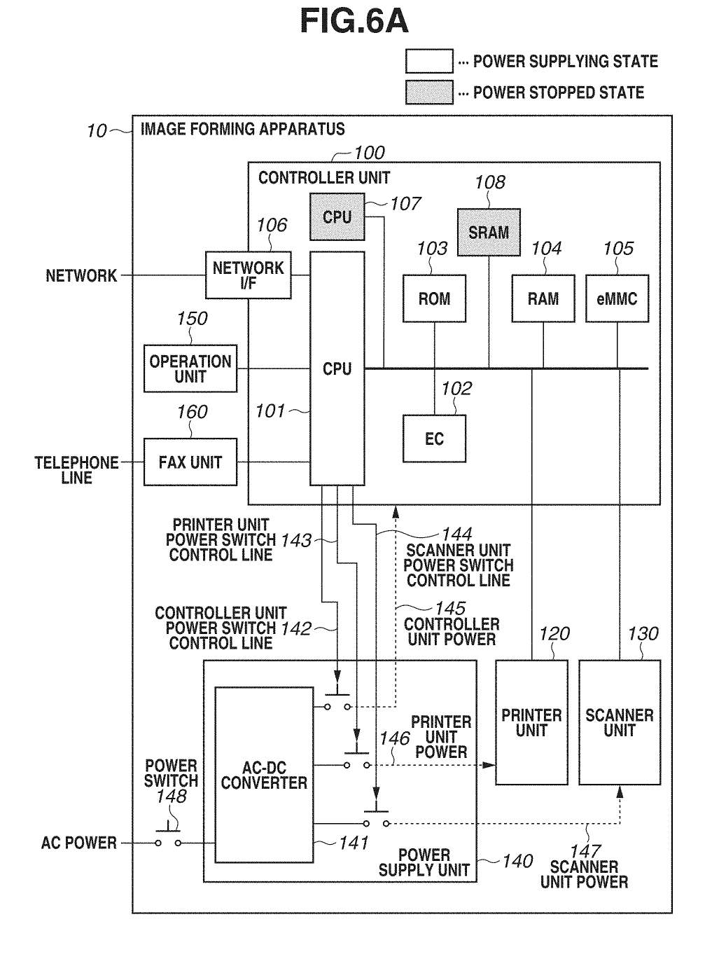

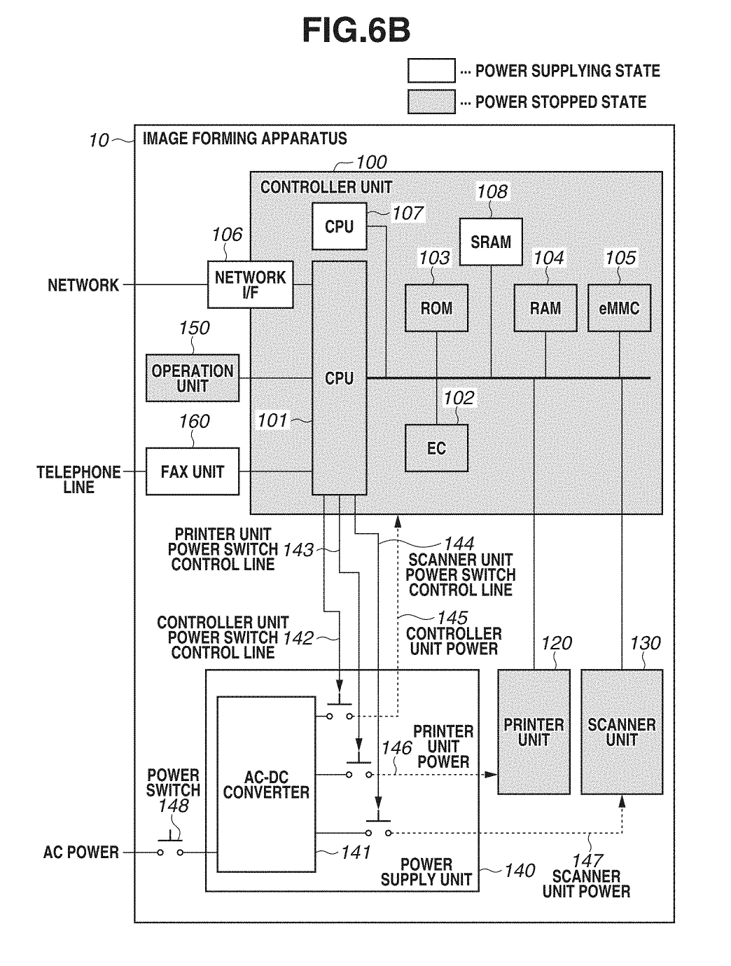

A CPU 101 controls the entire image forming apparatus 10. The CPU 101 is an example of a first control unit that controls the image forming apparatus 10 in a first power state. A power state illustrated in FIG. 6A described below is a normal power state, which is an example of the first power state.

A read only memory (ROM) 103 stores a boot program to start up the controller unit 100 and a fixed parameter.

An embedded controller (EC) 102 verifies the validity of the boot ROM program.

A random access memory (RAM) 104 is used as a work memory by the CPU 101.

An embedded Multi Media Card (eMMC) 105 stores a program to be executed by the CPU 101 and various data.

The eMMC 105 is used as a main storage of the CPU 101.

A network interface (I/F) 106 connects the image forming apparatus 10 to an external network via a wired local area network (LAN) or a wireless LAN.

A fax unit 160 transmits and receives digital images to and from a line such as a telephone line.

A power supply unit 140 supplies power for the image forming apparatus 10.

In a case where the image forming apparatus 10 is powered off, alternating current (AC) power is cut off by a power switch 148.

Direct current (DC) power is generated when the AC power is supplied to an AC-DC converter 141 by turning on of the power switch 148.

The image forming apparatus 10 performs power supply control in three independent modes for the entire image forming apparatus 10, based on an instruction of the CPU 101.

For example, a controller unit power switch control line 142 performs OFF/ON control for controller unit power 145 (i.e. power supply to the controller unit 100), based on an instruction of the CPU 101.

Similarly, based on an instruction of the CPU 101, a printer unit power switch control line 143 performs OFF/ON control for power supply to printer unit power 146, and a scanner unit power switch control line 144 performs OFF/ON control for power supply to scanner unit power 147.

FIG. 1 illustrates a simplified configuration.

For example, the CPU 101 includes CPU peripheral hardware components such as a chip set, a bus bridge, and a clock generator. However, these CPU peripheral hardware components are not significant for the description. Thus, the CPU 101 is illustrated in a simplified manner. The configuration illustrated in FIG. 1 is not intended to limit the present embodiment.

Operation of the controller unit 100 will be described using image printing on a paper medium as an example.

When a user provides an instruction for performing image printing via an I/F unit from an external apparatus such as a personal computer (PC), a fax, or the scanner unit 130, the CPU 101 temporarily saves digital image data by performing direct memory access (DMA) transfer to the RAM 104.

Upon determining that a predetermined amount or all of the digital image data having been saved in the RAM 104, the CPU 101 provides an image output instruction to the printer unit 120.

The CPU 101 notifies the location of the image data in the RAM 104. Based on a synchronization signal from the printer unit 120, the image data on the RAM 104 is transmitted to the printer unit 120, and the digital image data is printed on a paper medium at the printer unit 120.

In a case where printing of a plurality of copies is performed, the CPU 101 stores the image data on the RAM 104 into the eMMC 105. The CPU 101 can thereby transmit an image data to the printer unit 120 for the second and subsequent copies, without requesting the image data from the external apparatus.

The image forming apparatus 10 further includes a static random access memory (SRAM) 108 to be used as a work memory by the CPU 107 that operates only in a sleep mode. The CPU 107 is an example of a second control unit that controls the image forming apparatus 10 in a second power state in which power consumption is smaller than that in the first power state. A state illustrated in FIG. 6B (described below) is a power saving state that is an example of the second power state.

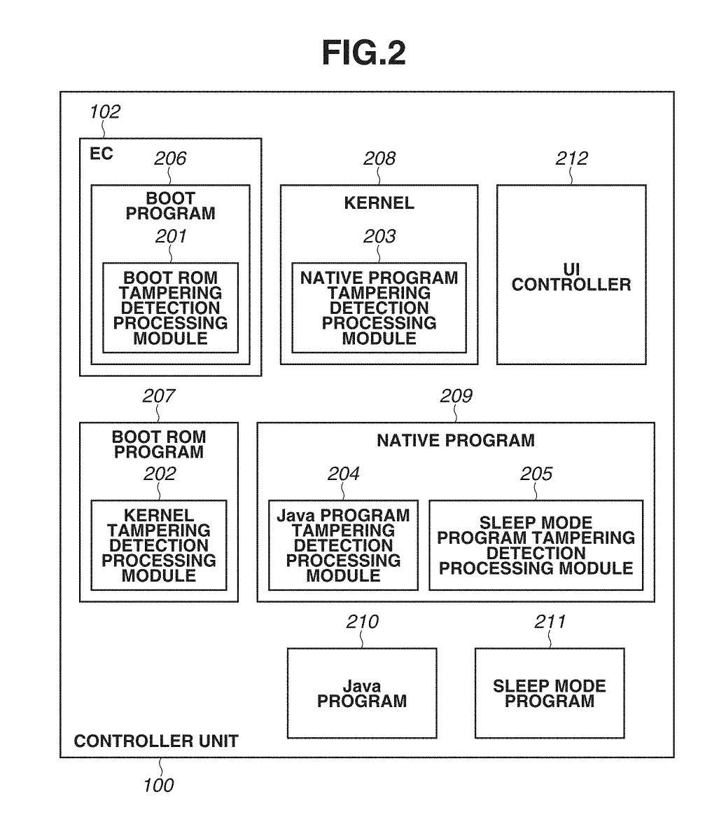

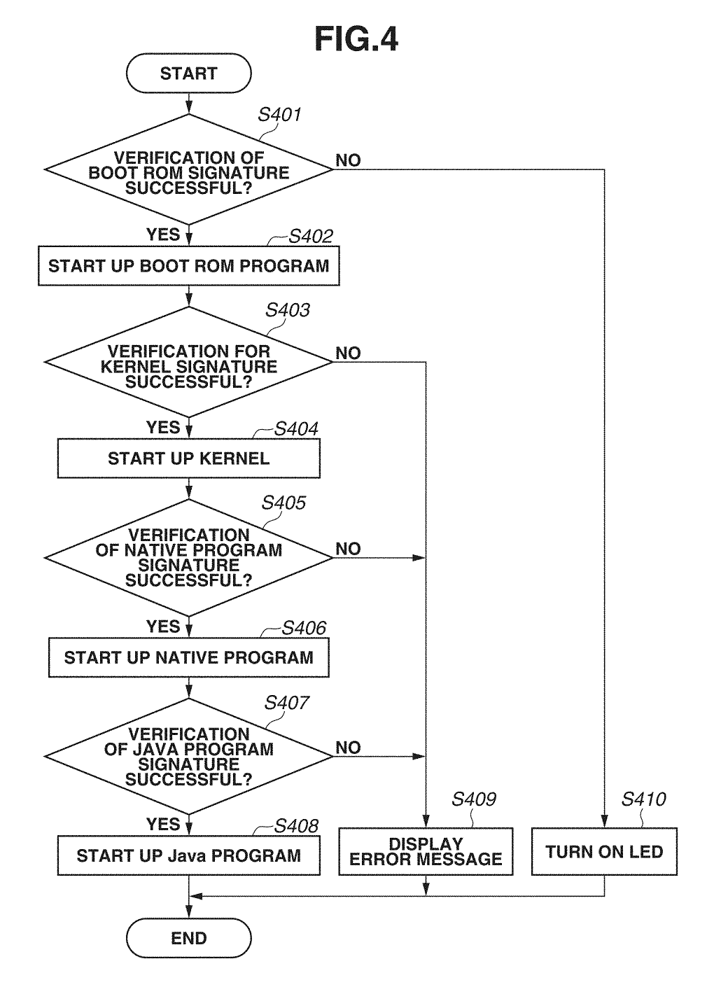

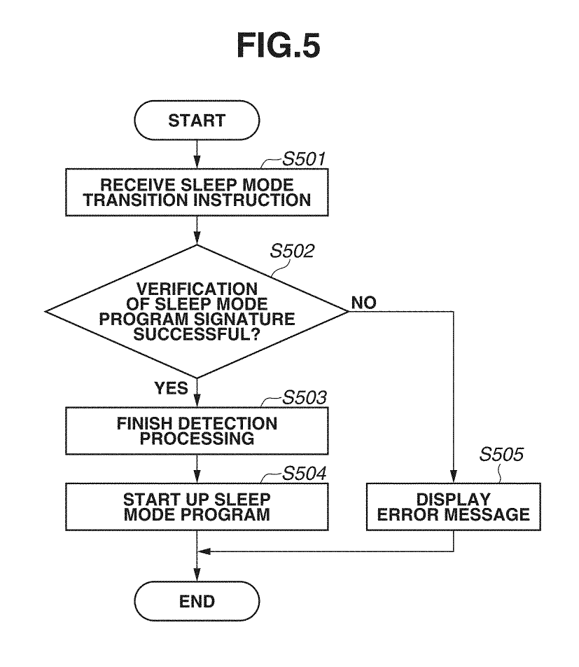

The CPU 101 executes processing based on a program stored in each of the ROM 103 and the EC 102, so that functions except for a boot program 206 and a sleep mode program 211 in FIG. 2 (described below) are implemented. Further, the CPU 101 executes processing based on a program stored in each of the ROM 103 and the EC 102, so that processing represented by a flowchart illustrated in each of FIG. 4 and FIG. 5 (described below) is implemented. The CPU 107 executes processing based on a program stored in the SRAM 108, so that the function of the sleep mode program 211 in FIG. 2 (described below) is implemented. Further, the EC 102 executes processing based on a program stored in the ROM 103, so that the function of the boot program 206 in FIG. 2 (described below) is implemented.

FIG. 2 is a block diagram illustrating an example of a configuration including a functional configuration of the image forming apparatus 10.

A user interface (UI) controller 212 receives an input to the operation unit 150, performs processing corresponding to the input, and displays a screen on the operation unit 150.

The boot program 206 is a program executed by the EC 102 when the image forming apparatus 10 is powered on. The boot program 206 performs processing related to start-up and includes a boot ROM tampering detection processing module 201 that detects tampering of the boot ROM program.

A boot ROM program 207 is a program executed by the CPU 101 after execution of the boot program 206 thereby. The boot ROM program 207 includes processing related to start-up and a kernel tampering detection processing module 202 that detects tampering of a kernel 208.

The kernel 208 is a program executed by the CPU 101 after completion of the processing by the boot ROM program 207. The kernel 208 includes processing related to start-up and a native program tampering detection processing module 203 that detects tampering of a native program 209.

The native program 209 is a program executed by the CPU 101. The native program 209 includes a plurality of programs that provides each function in cooperation with a Java® program 210 of the image forming apparatus 10. The native program 209 includes a program for controlling the scanner unit 130 and a start-up program. The kernel 208 calls the start-up program from the native program 209 to execute start-up processing. The native program 209 further includes a Java program tampering detection processing module 204 that detects tampering of the Java program 210 and a sleep mode program tampering detection processing module 205 that detects tampering of a sleep mode program 211.

The Java program 210 is a program executed by the CPU 101, and provides each function in cooperation with the native program 209 of the image forming apparatus 10 (e.g., a program for displaying a screen at the operation unit 150).

The sleep mode program 211 is a program executed by the CPU 107 in sleep mode transition. The sleep mode program 211 provides each function in the sleep mode (i.e., processing for a return-from-sleep instruction input from the network I/F 106 or the operation unit 150).

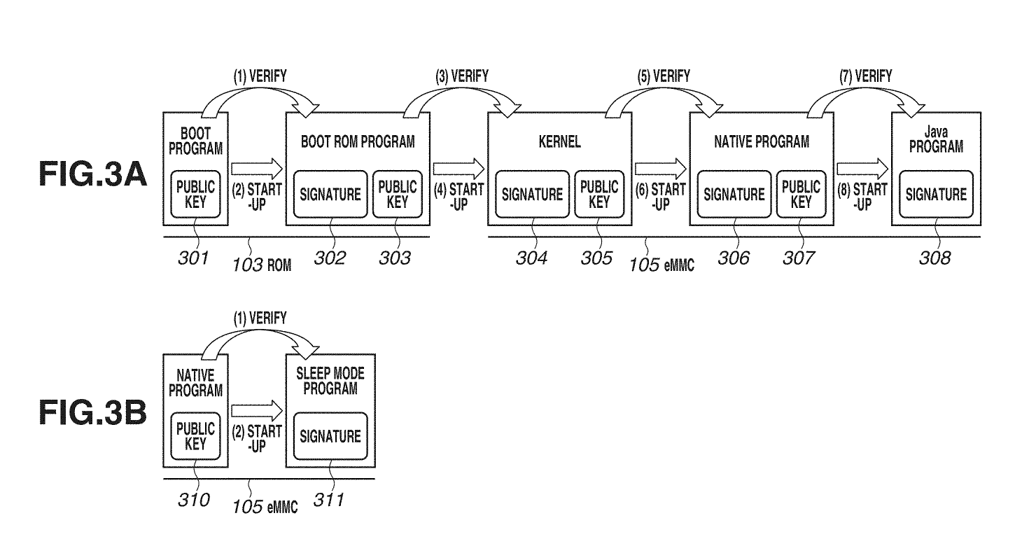

FIG. 3A is a schematic diagram illustrating a start-up sequence performed when tampering is detected at the start-up.

The boot program 206 includes a public key 301 for boot ROM signature verification. The boot ROM program 207 includes a boot ROM signature 302 and a public key 303 for kernel verification. The kernel 208 includes a kernel signature 304 and a public key 305 for native program signature verification. The native program 209 includes a native program signature 306 and a public key 307 for Java program signature verification. The Java program 210 includes a Java program signature 308.

FIG. 3B is a schematic diagram illustrating a start-up sequence performed when tampering detection processing in the sleep mode transition is performed.

The native program 209 includes a public key 310 for sleep mode program signature verification. The sleep mode program 211 includes a sleep mode program signature 311.

The detection processing modules 201, 202, 203, 204, and 205 verifies the programs and starts up the next program in a case where no tampering is detected. Thus, the start-up and the sleep mode transition of the image forming apparatus 10 are executed.

The signatures and public keys of the detection processing modules have been attached to the programs before shipment of the image forming apparatus 10.

FIG. 4 is a flowchart illustrating an example of information processing for tampering detection at a time of start-up.

When the image forming apparatus 10 is powered on, the boot program 206 is read out from the ROM 103, and the boot program 206 is executed by the EC 102. The boot ROM tampering detection processing module 201 included in the boot program 206 reads, from the eMMC 105, and stores, in the RAM 104, the boot ROM program 207 and the public key 303 and the boot ROM signature 302 for kernel verification.

In step S401, the boot ROM tampering detection processing module 201 performs verification of the boot ROM signature 302, using the public key 301 for boot ROM verification, and determines whether the verification is successful. If the verification of the boot ROM signature fails (NO in step S401), the processing proceeds to step S410. In step S410, the boot ROM tampering detection processing module 201 turns on the LED of the operation unit 150, and the processing of the flowchart illustrated in FIG. 4 ends.

In a case where the verification of the signature is successful (YES in step S401), the boot ROM tampering detection processing module 201 releases reset of the CPU 101 and the boot program 206 ends.

Upon the release of reset of the CPU 101, the processing proceeds to step S402. In step S402, the CPU 101 reads, from the eMMC 105, and stores, in the RAM 104, the boot ROM program 207 and the public key 303 for kernel verification, and starts up the boot ROM program 207.

Upon being started up, the boot ROM program 207 performs various kinds of initialization processing. The kernel tampering detection processing module 202 included in the boot ROM program 207 reads the kernel 208 from the eMMC 105 and stores the kernel 208 into the RAM 104.

In step S403, the kernel tampering detection processing module 202 verifies the kernel signature 304 using the public key 303 for kernel verification, and determines whether the verification is successful.

In a case where the verification of the signature fails (NO in step S403), the processing proceeds to step S409. In step S409, the kernel tampering detection processing module 202 displays an error message at the operation unit 150, and the processing of the flowchart illustrated in FIG. 4 ends.

In a case where the verification of the signature is successful (YES in step S403), the kernel tampering detection processing module 202 ends the processing, and the processing proceeds to step S404.

When the processing of the kernel tampering detection processing module 202 ends, the processing proceeds to step S404. In step S404, the boot ROM program 207 starts up the kernel 208 stored in the RAM 104.

Upon being started up, the kernel 208 performs various kinds of initialization processing.

The native program tampering detection processing module 203 included in the kernel 208 reads, from the eMMC 105, and stores, into the RAM 104, the native program 209, the public key 307 for Java program verification, and the native program signature 306.

In step S405, the native program tampering detection processing module 203 performs verification of the native program signature 306, using the public key 305 for native program verification, and determines whether the verification is successful.

In a case where the verification of the signature fails (NO in step S405), the processing proceeds to step S409. In step S409, the native program tampering detection processing module 203 displays an error message at the operation unit 150, and the processing of the flowchart illustrated in FIG. 4 ends.

In a case where the verification of the signature is successful (YES in step S405), the native program tampering detection processing module 203 ends the processing of the tampering detection, and the processing proceeds to step S406.

In step S406, the native program tampering detection processing module 203 starts up the native program 209.

Of the native program 209, the Java program tampering detection processing module 204 performs tampering detection is started up. When the Java program tampering detection processing module 204 starts up, it reads, from the eMMC 105, and sores, in the RAM 104, the Java program 210 and the Java program signature 308.

In step S407, the Java program tampering detection processing module 204 performs verification of the Java program signature 308 using the public key 307 for Java program verification, and determines whether the verification is successful.

If the verification of the signature fails (NO in step S407), the processing proceeds to step S409. In step S409, the Java program tampering detection processing module 204 displays an error message at the operation unit 150 and the processing of the flowchart illustrated in FIG. 4 ends.

If the verification of the signature is successful(YES in step S407), the Java program tampering detection processing module 204 ends the processing of the tampering detection and the processing proceeds to step S408.

In step S408, the Java program tampering detection processing module 204 starts up the Java program 210.

FIG. 5 is a flowchart illustrating an example of information processing when tampering detection is executed in the sleep mode transition.

Because the image forming apparatus 10 is in a start-up state, the components except for the CPU 107 and the SRAM 108 are supplied with power as illustrated in FIG. 6A.

In step S501, the CPU 101 receives a sleep mode transition instruction.

Each program and device generates the sleep mode transition instruction, for example, in a case where a state where a sleep mode shift button or a device mounted on the operation unit 150 has not been used for a predetermined time.

Of the native program 209, the sleep mode program tampering detection processing module 205 that performs tampering detection is started up. When the sleep mode program tampering detection processing module 205 reads, from the eMMC 105, and stores, into the RAM 104, the sleep mode program 211 and the sleep mode program signature 311.

In step S502, the sleep mode program tampering detection processing module 205 performs verification of the sleep mode program signature 311 using the public key 310 for sleep mode program signature verification, and determines whether the verification is successful.

If the verification of the signature fails (NO in step S502), the processing proceeds to step S505. In step S505, the sleep mode program tampering detection processing module 205 displays an error message at the operation unit 150, and the processing illustrated in FIG. 5 ends. In other words, in a case where the verification of the signature fails, the sleep mode program tampering detection processing module 205 stops a shift to the sleep state. In a case where the verification of the signature fails, the sleep mode program tampering detection processing module 205 may display a message while holding the shift to the sleep state. Afterward, the sleep mode program tampering detection processing module 205 may determine whether to limit the shift to the sleep state, based on an instruction of a user. The “limitation of the shift to the sleep state” includes stopping and holding the shift to the sleep state.

In a case where the verification of the signature is successful (YES in step S502), the processing proceeds to step S503. In step S503, the sleep mode program tampering detection processing module 205 ends the detection processing. Then, the CPU 101 releases reset of the CPU 107.

In step S504, the CPU 107 starts up the sleep mode program 211 by reading the sleep mode program 211 from the SRAM 108, and the image forming apparatus 10 transitions into the sleep mode.

As illustrated in FIG. 6B, at the sleep mode, power is supplied to the CPU 107, the SRAM 108, and the fax unit 160 and the network I/F 106 related to recovery from the sleep mode.

The embodiment of the present invention is described above as an example, but the present invention is not limited to this specific embodiment.

The present embodiment is described using the program and the CPU that operate only in the sleep mode, but other program may be adopted.

Although the ROM 103 and the eMMC 105 are described to be present as locations for saving various programs, the saving locations are not limited to these examples and other storage medium may be adopted.

According to the above-described embodiment, even in a case where tampering is detected in the sleep mode transition, it is possible to prevent damage from the tampering without affecting normal functions. Moreover, even in a case where the program that operates in the sleep state is tampered, it is possible to prevent processing from being executed based on the program in the sleep state.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2018-046573, filed Mar. 14, 2018, which is hereby incorporated by reference herein in its entirety.

What is claimed is:

1. An information processing apparatus configured to operate in a first power state and to operate in a second power state that saves more power than in the first power state, the information processing apparatus comprising:
a first processor configured to execute a first program to control the information processing apparatus operating in the first power state; and
a second processor configured to execute a second program to receive and process an instruction for shifting the information processing apparatus from the second power state to the first power state when the information processing apparatus operates in the second power state,
wherein the information processing apparatus verifies the first program to be executed by the first processor, and the second program to be executed by the second processor.

2. The information processing apparatus according to claim 1, wherein the information processing apparatus shifts into the second power state based on a satisfaction of a predetermined power state shift condition, and verifies the second program to be executed by the second processor before the information processing apparatus shifts into the second power state based on the satisfaction of the predetermined power state shift condition.

3. The information processing apparatus according to claim 1, further comprising an operation unit having a shift key for shifting the information processing apparatus into the second power state and having a screen for displaying information, wherein the second program receives, from the operation unit, the instruction for shifting the information processing apparatus from the second power state to the first power state when the information processing apparatus operates in the second power state, and processes the received instruction.

4. The information processing apparatus according to claim 1, further comprising a network interface configured to connect to a network that is present outside the information processing apparatus,
wherein the network interface is supplied with power when the information processing apparatus is in the first power state and when the information processing apparatus is in the second power state, and
wherein the second program receives, from the network interface, the instruction for shifting the information processing apparatus from the second power state to the first power state.

5. The information processing apparatus according to claim 1,
wherein at least a portion of the second processor is not supplied with power when the information processing apparatus is in the first power state, and
wherein at least the portion of the second processor is supplied with power when the information processing apparatus is in the second power state.

6. The information processing apparatus according to claim 5, further comprising a memory configured to be supplied with power and to store the second program when the information processing apparatus is in the second power state,
wherein the second processor operates based on the second program stored in the memory being supplied with power, when the information processing apparatus is in the second power state.

7. The information processing apparatus according to claim 1, further comprising a memory configured to be supplied with power and to store the second program when the information processing apparatus is in at least the second power state,
wherein the second processor processes, when the information processing apparatus is in the second power state, the instruction for shifting the information processing apparatus from the second power state to the first power state, based on the second program stored in the memory being supplied with power.

8. The information processing apparatus according to claim 1,
wherein at least a portion of the first processor is supplied with power when the information processing apparatus is in the first power state, and
wherein at least the portion of the first processor is not supplied with power when the information processing apparatus is in the second power state.

9. The information processing apparatus according to claim 1, wherein the first program receives an instruction for shifting the information processing apparatus into the second power state.

10. The information processing apparatus according to claim 1,
wherein the first program is verified using a key corresponding to the first program, and
wherein the second program is verified using a key corresponding to the second program.

11. The information processing apparatus according to claim 1, wherein the first processor verifies both of the first program and the second program.

12. The information processing apparatus according to claim 1, wherein the first processor verifies the second program before the information processing apparatus shifts into the second power state.

13. The information processing apparatus according to claim 1, wherein a verification program for verifying the second program is stored in the information processing apparatus, and the first processor verifies the verification program and verifies the second program according to the verified verification program.

14. The information processing apparatus according to claim 1, wherein the first program includes at least an OS (Operating System), and an application program operating on the OS.

15. An information processing apparatus comprising:
a first control unit configured to control the information processing apparatus in a first power state; and
a second control unit configured to control the information processing apparatus in a second power state in which power consumption is smaller than that in the first power state,
wherein the first control unit performs verification of a program related to execution of processing by the second control unit in a case where the first control unit receives an instruction for transition from the first power state to the second power state, and in a case where the verification fails, the first control unit limits the transition from the first power state to the second power state.

16. The information processing apparatus according to claim 15, wherein the first control unit causes an error message to be displayed and limits the transition from the first power state to the second power state, in a case where the verification fails.

17. The information processing apparatus according to claim 15,
wherein the first power state is a normal power state, and
wherein the second power state is a power saving state.

18. The information processing apparatus according to claim 17, wherein the power saving state is a state in which power is supplied to a network interface, a fax unit, the second control unit, and a storage unit that stores the program.

19. The information processing apparatus according to claim 15, further comprising an image forming unit configured to form an image,
wherein the information processing apparatus is an image forming apparatus.

20. A control method for an information processing apparatus configured to operate in a first power state and to operate in a second power state that saves more power than in the first power state, the control method comprising:
verifying a first program that controls the information processing apparatus in the first power state;
verifying a second program that receives and processes, when the information processing apparatus operates in the second power state, an instruction for shifting the information processing apparatus from the second power state to the first power state;
executing the verified first program to control the information processing apparatus operating in the first power state; and
executing the verified second program before the information processing apparatus shifts into the second power state.

21. The control method according to claim 20, wherein the second program processes, when the information processing apparatus is in the second power state, the instruction received via a network interface that connects to a network that is present outside the information processing apparatus.
